(19) United States
(12) Patent Application Publication
(10) Pub. No.: US 2006/0120788 A1
(43) Pub. Date: Jun. 8, 2006

(54) Method of, and apparatus for, processing tape

(75) Inventor: Hideyuki Takahashi, Omachi-shi (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/294,723

(22) Filed: Dec. 5, 2005

(30) Foreign Application Priority Data
Dec. 7, 2004 (JP) 2004-354527

(51) Int. Cl. B41J 3/32; B41J 11/70

(52) U.S. Cl. 400/109.1; 400/621

(57) ABSTRACT

A method of processing a tape includes: embossing Braille on an elongated rectangular processing tape in an embossing region which is set in advance on the processing tape; and embossing an end mark which shows an end of a Braille embossing operation. The embossing of the end mark is made in a marking region which follows the embossing region of the processing tape.

The entire disclosure of Japanese Patent Application No. 2004-354527, filed Dec. 7, 2004, is expressly incorporated by reference herein.

### BACKGROUND

1. Technical Field

The present invention relates to a method of, and an apparatus for, processing a tape in which Braille (raised letters) are embossed on an elongated rectangular processing tape (i.e., a tape which is subjected to processing) and in which an end mark representing an end of the embossing operation is embossed thereon.

2. Related Art

There is known an apparatus for processing a tape which has mounted thereon a Braille embossing mechanism for embossing Braille on an elongated rectangular embossing tape. This Braille embossing mechanism is made up of: three embossing pins which are driven by solenoids to thereby form vertically arrayed three embossed projections; and a tape-feeding roller which feeds an introduced embossing tape in one direction. The three embossing pins are selectively driven by the solenoids while feeding the Braille tape by means of the tape-feeding roller, thereby forming the so-called six-point Braille embossing on a Braille tape. Japanese Utility Model Registration No. 3054580 is an example of related art.

In this kind of tape processing apparatus, there is the following possibility. Namely, when the elongated rectangular Braille embossing tape is within an originally designed dimension, if the amount of feeding the tape becomes large relative to the embossing timing due to dirt, or the like, adhered to the circumference of the tape-feeding roller, the rear end of the Braille array will fall out of the embossing tape. If this occurs, the person having an ordinary eyesight who cannot understand the Braille will not be able to recognize whether the Braille array has been successfully embossed to the end, resulting in a problem in that an incomplete Braille label will be formed.

### SUMMARY

An advantage of some aspects of the invention is to provide a method of, and an apparatus for, processing a tape in which the end of the Braille embossing can be recognized also by the person having an ordinary eyesight.

According to a first aspect of the invention, a method of processing a tape comprises: embossing Braille on an elongated rectangular processing tape in an embossing region which is set in advance on the processing tape; and embossing an end mark which shows an end of a Braille embossing operation. The embossing of the end mark is made in a marking region which follows the embossing region of the processing tape.

In accordance with an embodiment of the invention, Braille are embossed in the embossing region of the processing tape and an end mark is embossed in the following marking region. This end mark enables even the person having an ordinary eyesight who cannot understand the Braille to see whether the embossing of the Braille has been finished or not. Therefore, there is no possibility of forming an incomplete Braille label. Needless to say, it must be so arranged that the person having an ordinary eyesight can distinguish the Braille and the end mark.

It is preferable that the processing tape comprises a recording tape and a release tape adhered to a rear surface of the recording tape, the method further comprising forming on a border between the embossing region and the marking region a half-cutting line for cutting only the recording tape.

In accordance with an embodiment of the invention, the embossing region and the marking region can be clearly recognized by the half-cutting line which is formed in the processing tape. Further, since the embossing region and the marking region are separate, only that embossing region of the recording tape which has embossed thereon the desired Braille can be adhered to an object of adhesion. In addition, since the end mark does not remain in the recording tape, the user will not suffer from the feeling which is quite foreign to the ordinary touch when reading the Braille with fingers.

According to another aspect of the invention, an apparatus for processing a tape comprises: Braille embossing means for embossing Braille on an elongated rectangular processing tape based on inputted Braille information; region-setting means for setting on the processing tape a region for embossing therein Braille; and control means for controlling the Braille embossing means. The control means controls the Braille embossing means such that Braille are embossed in the embossing region and that an end mark showing an end of a Braille embossing operation is embossed in a marking region which follows the embossing region of the processing tape.

In accordance with an embodiment of the invention, the region setting means sets the region for setting therein Braille based on the inputted Braille information. The Braille embossing means which is subjected to the control of the control means embosses Braille in the embossing region of the processing tape, and also embosses the end mark in the marking region which follows the embossing region. This end mark enables even the person having an ordinary eyesight who is unable to understand the Braille to recognize as to whether the embossing of the Braille has come to an end or not. As a result, there is no possibility of forming an incomplete Braille label.

It is preferable that the processing tape has a recording tape and a release tape adhered to a rear surface of the recording tape, that the control means further comprises half-cut means for cutting only the recording tape of the processing tape, and that the control means controls the half-cut means such that a half-cut line is formed on a border between the embossing region and the marking region.

In accordance with an embodiment of the invention, the half-cut line is formed only in the recording tape of the processing tape by the half-cut means under the control of the control means. Due to this half-cut line, the embossing region and the marking region can be clearly distinguishable. In addition, since the embossing region and the marking region are separate, only that embossing region of the recording tape which has embossed therein the desired Braille can be adhered to an object of attaching the label. Still furthermore, since the end mark does not remain in the recording tape, the user will not suffer from the feeling which is quite foreign to the ordinary touch when reading the Braille with fingers.

It is preferable that the end mark is made up of an embossing pattern which is different from an embossing pattern representing Braille.

In accordance with an embodiment of the invention, the person having an ordinary eyesight is prevented from wrongly recognizing that a Braille is embossed in the marking region. In addition, the end of embossing of the Braille can be accurately recognized.

It is preferable that the embossing pattern of the Braille is formed by embossed projections which are selectively embossed in six-point embossing cells, and that the embossing pattern of the end mark is formed by embossed projections which are embossed in all of the six-point embossing cells arranged in a narrower width than the ordinary width for the embossing cells.

In accordance with an embodiment of the invention, since the end mark is formed by embossed projections (embossing pattern) which is disposed in all of the six embossing points in the six-point embossing cell at a distance which is different from that of the ordinary Braille, the person having an ordinary eyesight can easily recognize it. Further, the end mark can be formed by an easy control using the embossing means for embossing the Braille.

It is preferable that the apparatus further comprises: a cartridge mounting section for detachably mounting a tape cartridge into which is housed an elongated processing tape in a rolled shape; and a full-cut means for cutting off the elongated processing tape which is paid out of the mounted tape cartridge, thereby obtaining the elongated rectangular processing tape.

In accordance with an embodiment of the invention, the elongated processing tape which is contained in the tape cartridge is cut (full-cut) by the full-cut means to thereby form a rectangular processing tape of the desired size. Braille can thereafter be embossed on the tape thus obtained. In addition, there can be formed a Braille label depending on the length of the Braille (Braille array) and the end mark.

It is preferable that the apparatus further comprises printing means for printing ink characters while feeding the elongated processing tape, the printing being made before cutting off the tape by the full-cut means.

In accordance with an embodiment of the invention, there can be manufactured a processing tape in which the Braille and ink characters are disposed in parallel with each other. As a result, it is possible to print ink characters which represent the meaning of the Braille. There can thus be manufacture a processing tape which can be understood even by the person having an ordinary eyesight.

### BRIEF DESCRIPTION OF THE DRAWINGS

The invention will be described with reference to the accompanying drawings, wherein like numbers reference like elements.

FIG. 1 is a perspective view of a tape processing apparatus.

FIG. 2A is a plan view of a Braille embossing assembly and FIG. 2B is a side view thereof.

FIG. 3A is a schematic view to explain the six-point Braille and FIG. 3B is a sectional view of a Braille.

FIG. 4 is a sectional view showing an inner structure of a tape cartridge.

FIG. 5 is a block diagram showing the control arrangement of the tape processing apparatus.

FIG. 6A is a processing tape which is paid out of the tape cartridge, FIG. 6B is a processing tape having formed therein a half-cut line, and FIG. 6C is a processing tape having embossed Braille and an end mark, all of the aforementioned processing being performed in accordance with the procedures of the tape processing method of the embodiment.

FIGS. 7A to 7D are schematic plan views showing other examples of the processing tape.

### DESCRIPTION OF EXEMPLARY EMBODIMENTS

The invention will be described with reference to the accompanying drawings, wherein like numbers reference like element.

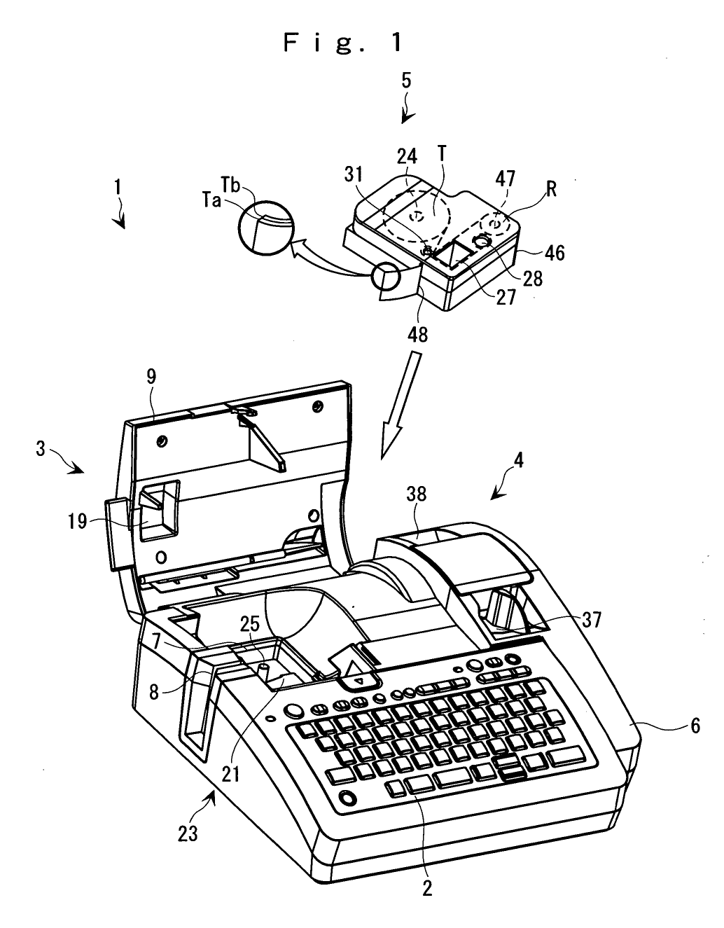

As shown in a perspective outside view in FIG. 1, an apparatus for processing a tape (hereinafter also referred to as a tape processing apparatus 1) includes a printing section 3 which performs ink-character printing on a processing tape T (i.e., which performs printing of ink characters on a tape T to be processed), and a Braille embossing section 4 which performs embossing of Braille. The processing tape T is subjected to printing of ink characters in the printing section 3, and the processing tape T discharged therefrom is manually inserted into the embossing section 4 so that the embossing of Braille can be performed therein. The processing tape T is contained in a tape cartridge 5 and is detachably mounted on the tape processing apparatus 1.

The tape processing apparatus 1 has an outline formed by an apparatus casing 6. Inside the apparatus casing 6 there are contained the main parts of the printing section 3 and the embossing section 4. The printing section 3 constitutes the main portion of the tape processing apparatus 1. The embossing section 4 is housed in the right rear portion of the tape processing apparatus 1.

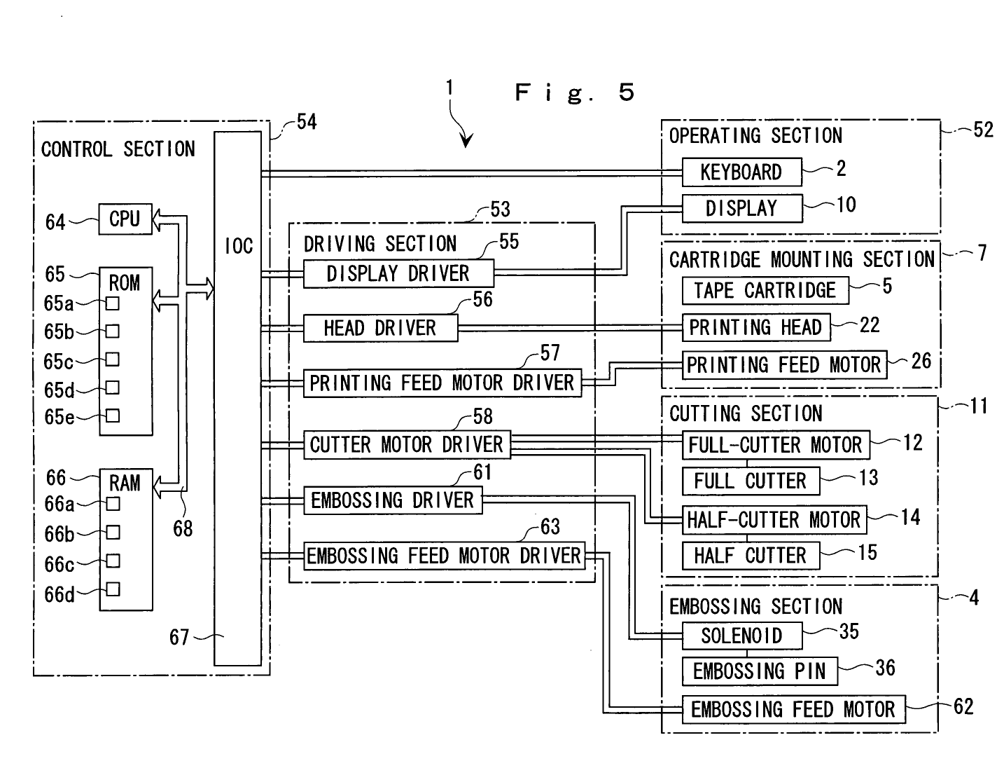

On a front upper surface portion of the printing section 3 there is disposed a keyboard 2 which is provided with various input keys. An open-close lid 9 is mounted on a rear upper surface portion of the printing section 3. A display 10 (see FIG. 5) is disposed on a front surface of the open-close lid 9. On an inner side of the open-close lid 9 there is formed a cartridge mounting section 7 in a recessed manner so that the tape cartridge 5 can be fit thereinto. On a left portion of the open-close lid 9 there is formed a peep hole 19 for visually confirming the presence (mounting) or absence of the tape cartridge 5 inside, in a state in which the open-close lid 9 is kept closed. The apparatus casing 6 is provided on a right side surface portion with a power supply port (not shown) for supplying electric power.

The left side surface of the apparatus casing 6 is provided with a tape discharge port 8 which communicates the cartridge mounting section 7 and the outside of the apparatus. A cutting section 11 (see FIG. 5) is formed so as to face the tape discharge port 8 from inside the casing. There are built inside the cutting section 11 a full cutter 13 (full-cut means) for full-cutting the processing tape T by driving it with a full-cutter motor 12, and a half cutter 15 (half-cut means) for half-cutting the processing tape T by driving it with a half-cutter motor 14 (see FIG. 5).

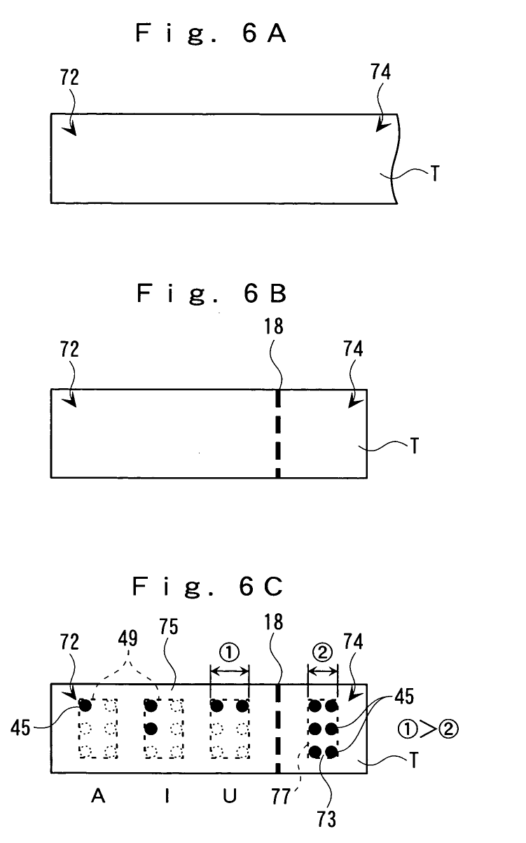

Although not shown, the full cutter 13 is made into a shape of a pair of scissors. Once this full cutter 13 is subjected to a cutting operation, both a recording tape Ta and a release (peel-off) tape Tb of the processing tape T, to be described in detail hereinafter, which face the full cutter 13 are cut off, i.e., the processing tape T is full-cut. Similarly, the half cutter 15 is made into a shape of a pair of scissors with a stopper added thereto. Once the half cutter 15 is subjected to a cutting operation, only that recording tape Ta of the processing tape T which faces the half cutter 15 is cut, i.e., the processing tape T is half-cut. As a result of this half cutting, a half-cutting line 18 is formed in the recording tape Ta (see FIG. 6B).

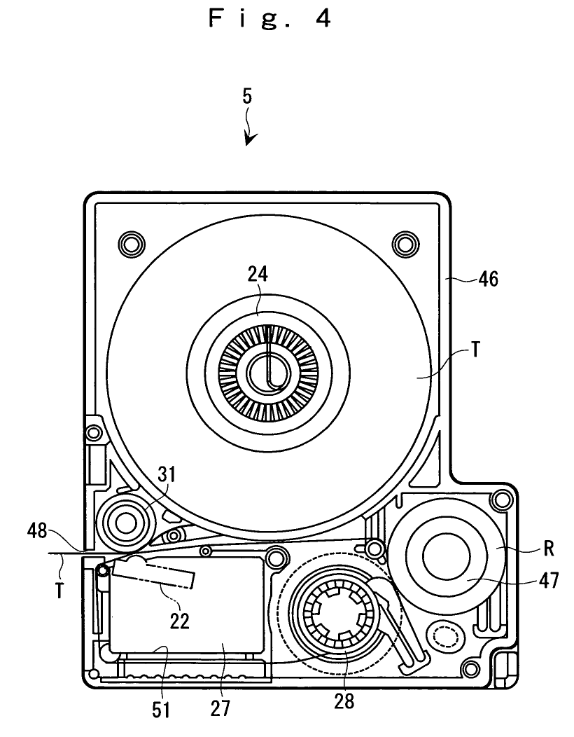

In the cartridge mounting section 7 there are provided in a projecting manner: a head unit 23 (printing means) which is formed by containing inside a head cover 21 a printing head 22 in the form of a thermal head (see FIG. 4); a platen drive shaft (not shown) which lies opposite to the printing head 22; a take-up drive shaft (not shown) which takes up an ink ribbon R (see FIG. 4); and a positioning projection 25 which holds the tape reel 24 in position (see FIG. 4). In a lower space under the cartridge mounting section 7 there are contained a printing feed motor 26 (see FIG. 5) which rotates the platen drive shaft and the take-up drive shaft, and a power transmission mechanism (not shown).

Once the tape cartridge 5 is mounted in position in the cartridge mounting section 7, the head unit 23 is inserted into a through hole 27 (to be described in detail hereinafter) of the tape cartridge 5, the positioning projection 25 is inserted into the tape reel 24, the take-up drive shaft is inserted into the ribbon take-up reel 28, and the platen drive shaft is inserted into a platen roller 31, respectively. As a result, the printing head 22 comes into contact with the platen roller 31 with the processing tape T and the ink ribbon R held therebetween, thereby attaining a state ready for printing ink characters (see FIG. 4). The processing of ink-character printing is performed by driving the printing head 22 against the processing tape T to be fed from the platen roller 31, the printing being made based on the inputted ink-character data. The processing tape T after passing through the processing of ink-character printing is subjected to cutting processing (full cutting or half cutting) by means of the cutting section 11, and is thereafter discharged out of the tape discharge port 8. In case embossing of Braille is further performed, the processing tape T that has been cut as noted hereinabove is manually fed into the embossing section 4.

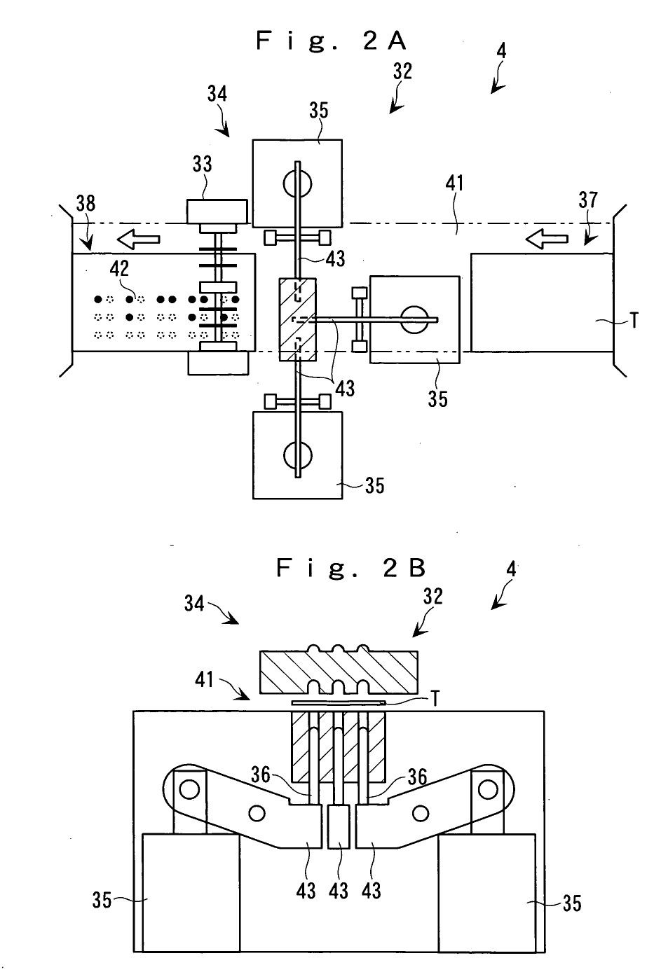

The embossing section 34 contains therein, as shown in FIGS. 2A and 2B, a Braille embossing assembly 34 which constitutes a main apparatus having built therein an embossing unit 32 (Braille embossing means) and a tape feeding mechanism 33. The embossing unit 32 has three embossing pins 36 which perform embossing operation with three solenoids 35 serving as driving sources. The embossing unit 32 selectively drives the three embossing pins 36 toward the processing tape T which is fed by the tape feeding mechanism 33 from the tape introducing port 37 to the tape outlet port 38, thereby embossing Braille 42 (i.e., a plurality of embossed projections) on the processing tape T. There is connected a rotating link 43 between each of the solenoids 35 and the corresponding embossing pin 36. When the solenoid 35 is sucked (energized) to thereby cause the rotating link 43 to rotate, the embossing pin 36 is pushed upward to thereby emboss a Braille on the processing tape T. The three solenoids 35 are arranged to be driven with a time difference from each other.

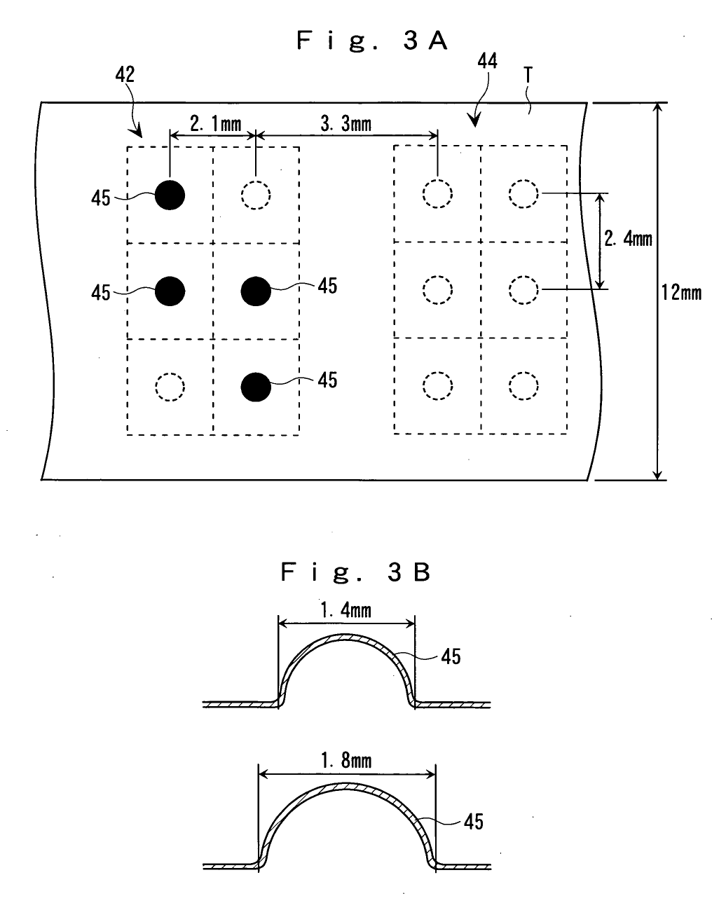

FIG. 3A shows the positional relationship between a six-point Braille 42 embossed by the embossing unit 32 and a six-point Braille 44 which lies adjacent thereto. The Braille 42 represents Japanese hiragana “SHI”. Normally, each Braille is formed within a Braille cell 49 which is made up of a total of six points arranged in two rows disposed in a side-by-side relationship, each row having three vertically arranged points. Each Braille cell serves not only to represent a single Braille but also to represent attributes (or properties) such as a voiced sound (i.e., a Japanese voiced sound such as “GA,” “GI,” “GU,” “GE,” “GO” is represented by a combination of two Braille cells). The pitch between points of the six-point Braille is about 2.4 mm as seen in the vertical direction and about 2.1 mm as seen in the lateral direction. The pitch between the adjoining Braille cells is about 3.3 mm. In the example shown in FIG. 3A, the Braille “SHI” 42 is made up of four embossed projections 45 which are embossed by driving the embossing pins 36. The embossed projections 45 are shown black.

As the Braille 42, there are six-point Braille which represent Japanese katakana, numerals, or the like, as well as eight-point Braille which represent Chinese characters by means of four vertical points and two horizontal points, i.e., an eight-bit pattern. The apparatus 1 for processing a tape according to this embodiment is to emboss six-point Braille. It may, of curse, be arranged to be capable of embossing eight-point Braille.

FIG. 3B is a cross-sectional view of an embossed projection 45. As shown therein, the embossed projection 45 has a hemispherical shape. The shape of the embossed projection 45 may alternatively be of a cylindrical shape with a rounded corner for better feeling to the touch. Other shapes such as conical shape or quadrangular pyramid shape is also acceptable.

A description will now be made about the tape cartridge 5 with reference to FIG. 4. The tape cartridge 5 contains the processing tape T inside a cartridge case 46 in a manner to be capable of paying out (or reeling out) and also contains the ink ribbon R in a manner to be capable of being paid out. The processing tape T is made up of a recording tape Ta which has an adhesive agent layer (not shown) on a rear surface of the recording tape, and a peeling (or peel-off) tape Tb which is adhered to the rear surface of the recording tape Ta by means of the adhesive agent layer (see FIG. 1). There are prepared, as the processing tape T, plural kinds of tapes of varying widths of 12 mm and 24 mm, as well as of varying classifications (tape color, color of ink characters, or the like).

FIG. 4 shows a sectional view of an internal structure of the cartridge 5. As shown therein, the tape cartridge 5 contains inside the cartridge case 46 which constitutes an outer limit: a tape reel 24 around which is wound the processing tape T; a ribbon pay-out reel 47 around which is wound the ink ribbon R of substantially the same width; and a ribbon take-up reel 28. On the left lower side of the tape cartridge 4, there is contained the platen roller 31. The processing tape T which is wound around the tape reel 24 is held in the cartridge case 46 with the front end thereof slightly projecting from a tape discharge slit 48.

On the lower left portion of the tape reel 24, there is formed a through hole 27 for inserting thereinto the aforementioned head unit 23. The platen roller 31 which is fitted into the platen drive shaft on the apparatus side is disposed so as to correspond to the portion in which the processing tape T and the ink ribbon R are overlapped with each other. The ink ribbon R which is paid out of the ribbon pay-out reel 47 is fed in a manner to go around an opening wall 51 which constitutes the through hole 27 and is taken up by the ribbon take-up reel 28. The processing tape T once paid out of the tape reel 24 is put, at the platen roller 31, on top of the ink ribbon R which is paid out of the ribbon pay-out reel 47. The processing tape T is thus subjected to thermal transfer printing by the printing head 22. The processing tape T once printed is discharged out of the tape discharge slit 48, and the ink ribbon R is taken up by the ribbon take-up reel 28.

With reference to FIG. 5, a description will now be made about the arrangement of the tape processing apparatus 1 according to this embodiment. The tape processing apparatus 1 is made up of: an operating section 52 having a keyboard 2 and a display 10; the cartridge mounting section 7 in which the tape cartridge 5 is mounted; the cutting section 11 having the full cutter 13 and the half cutter 15; the embossing section 4 for performing the embossing of Braille; a driving section 53 for driving each of the sections; and a control section 54 (control means) which is connected to each of the sections to thereby control the entire tape processing apparatus 1.

The driving section 53 is made up of: a display driver 55 for driving the display 10; a head driver 56 for driving the printing head 22; a motor driver 57 for driving the printing feed motor 26 (also referred to as a printing feed motor driver), as well as a cutter motor driver 58 for driving the full-cutter motor 12 and the half-cutter motor 14 in the cutting section 11; an embossing driver 61 for driving the solenoids 35 and the embossing pins 36 in the embossing section 4; and an embossing feed motor driver 63 for driving an embossing feed motor 62 in the driving section 4, thereby driving various kinds of actuators (solenoids and motors).

The control section 54 is made up of a CPU 64, a ROM 65, a RAM 66 and an input/output controller (hereinafter referred to as IOC) 67, all of which are connected to one another with an internal bus 68. The ROM 65 is made up of: a control program block 65a which stores therein a control program for controlling various processing such as ink-character printing processing, Braille embossing processing, or the like, by means of the CPU 64; a data control block 65b which stores therein data such as character font data for performing ink-character printing, character size data, Braille font data for performing Braille embossing, or the like; a translate into Braille program block 65c which stores therein a translate into Braille program for translating the Braille information as inputted by means of ink characters into Braille data; an input editing program block 65d which stores therein an input editing program for displaying an input editing screen (not shown); and a region setting program block 65e which stores therein a region setting program (region setting means) for setting an embossing region on the processing tape T.

The input editing program includes various processing modes (first processing mode only for ink characters; second processing mode only for Braille; and third processing mode for both ink characters and Braille). The input editing program operates to cause the user to select one of the aforementioned processing modes in the input editing screen displayed on the display 10 and then to input data in a predetermined procedure, thereby generating ink-character data and Braille data (Braille information) which are made the basis for tape processing in the tape processing apparatus 1.

The region-setting program operates to set on the processing tape T at least one of a printing region 71 for printing therein ink characters and a Braille embossing region (also simply referred to as an embossing region) 72 for embossing therein Braille based on the aforementioned ink-character data and the Braille data. The region data relating to the ink-character printing region 71 and the embossing region 72 which are set as mentioned above is temporarily stored in the RAM 66 for further use in performing the ink-character printing processing and the Braille embossing processing.

The RAM 66 includes: a various work area block 66a; an ink-character data block 66b for storing therein generated ink-character data; a Braille data block 66c for storing therein generated Braille data; and a region data block 66d for storing therein region data relating to the aforementioned ink-character printing region 71 and the embossing region 72. The RAM 66 is constantly backed up so that the stored data can be maintained even in case of power failure.

The IOC 67 contains therein a logic circuit which supplements the function of the CPU 64 and which also handles the interface signals with various peripheral circuits, the logic circuit being constituted by a gate array, a custom LSI, or the like. According to this arrangement, the IOC 67 captures the input data or control data from the keyboard 2 into the internal bus 68 as it is or with modification and also, in interlocking with the CPU 64, outputs to the driving section 53 the data or the control signal as outputted from the CPU 64 to the internal bus 68 as it is or with modification.

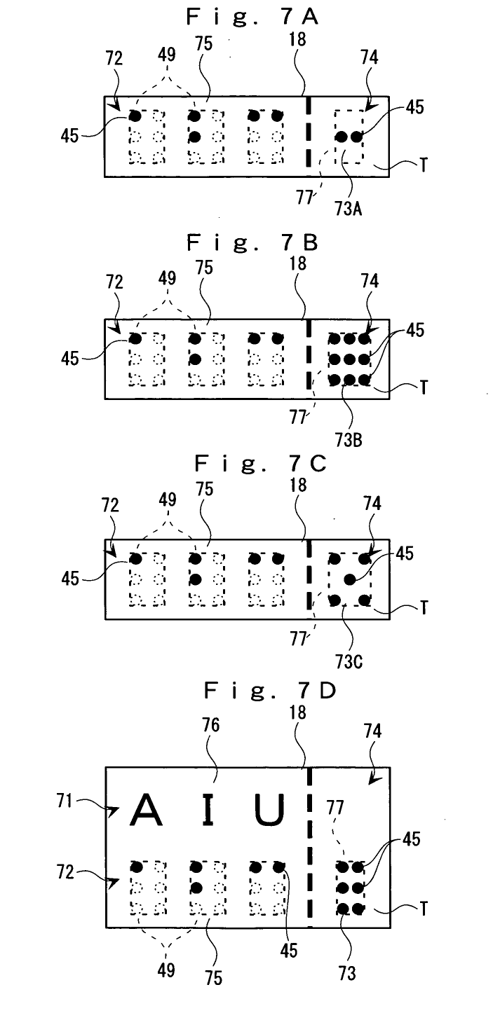

When the user inputs the data through the keyboard 2 in accordance with the input editing program started up in the CPU 64, the ink-character data and the Braille data are generated. These generated ink-character data and the Braille data are respectively stored in the ink-character data block 66b and the Braille data block 66c of the RAM 66. Thereafter, when the user commands to start the processing of any one of various processing modes, the CPU 64 starts up the region setting program as read out from the ROM 65, thereby setting the ink-character printing region 71 and the embossing region 72 on the processing tape T (see FIG. 7D). The control program subsequently starts up to output the control signal to the driving section 53 through the IOC 67 based on the aforementioned ink-character data and the Braille data. The head driver 56 and the embossing driver 61 having received the control signal directly drive the printing head 22 and the solenoids 35, respectively, thereby performing the ink-character printing processing and the Braille embossing processing in the printing region 71 and the embossing region 72, respectively, of the processing tape T.

With reference to FIGS. 6A to 6C, a description will now be made about a tape processing procedure (method of processing a tape) using the tape processing apparatus 1 of the embodiment. In this processing procedure, the user inputs data into the tape processing apparatus 1 in accordance with the input editing program and prepare a processing tape T in which desired Braille (ink characters) are embossed (printed).

Suppose that the tape processing apparatus 1 has started up the input editing program and the translate into Braille program, and the display 10 has displayed an input editing screen. When the user selects the second processing mode (i.e., only Braille embossing) and inputs desired Braille information (in this example, Japanese hiragana characters “A”, “I” and “U” as represented in alphabets; Braille in FIG. 6C represent Japanese hiragana, not alphabets) in the form of ink characters, the CPU 64 functions to translate the Braille information in the form of ink characters into Braille data in accordance with the translate into Braille program. Further, the region-setting program is started up in the CPU 64 and thus sets the embossing region 72 based on that length of the Braille array which is calculated by the Braille data. The region-setting program also sets a marking region 74 based on the length of an end mark 73 (actually, region data relating to the embossing region 72 and the marking region 74 is stored in the region data block 66d).

When the user commands to start the embossing of Braille, the printing section 3 functions to drive the platen roller 31 and, as shown in FIG. 6B, the processing tape T facing the cutting section 11 is cut into an elongated rectangular shape. Further, the processing tape T is subjected, while being fed, to half-cut processing in which half cutter 15 is driven to thereby form a half-cutting line 18 which cuts only the recording tape Ta along the border between the embossing region 72 and the marking region 74.

Subsequently, when the user manually feeds the processing tape T that has been cut into an elongated rectangular shape into the embossing section 4, the processing tape T is fed by the tape feeding mechanism 33. Also, as shown in FIG. 6C, the Braille array 75 made up of “A”, “I” and “U” is embossed by the Braille embossing unit 32 in the embossing region 72 of the processing tape T. In the marking region 74 which follows the embossing region 72, an end mark 73 is embossed by the embossing unit 32.

The end mark 73 is made up of a plurality of (six) embossed projections 45 which are formed by embossing all of the six embossing points which are used in the six-point Braille. It is, however, to be noted that the three embossed projections 45 on the right-hand side are embossed at a timing which is slightly shorter (or earlier) than that for embossing ordinary Braille. As a result, the end mark 73 has the following construction. Namely, while the pitch of the embossed projections in the vertical direction is made at the same distance as that of an ordinary Braille, the pitch of the embossing points in the lateral (horizontal) direction is made smaller (below 2.1 mm) such that the width of the embossing cell 77 becomes narrower (smaller in the horizontal direction) than that of the ordinary Braille cell 49. According to this arrangement, the user can clearly recognize the difference between the Braille array 75 and the end mark 73. The end mark 73 can thus be formed only by accelerating the timing of embossing. Therefore, the end mark 73 whose difference from the Braille array 75 is recognizable can be easily formed without complicating the construction of the embossing section 4.

It is so arranged in this embodiment that the end mark 73 is embossed. Actually, it may alternatively be so arranged that only the half-cut line 18 is formed on the border between the embossing region 72 and the marking region 74 of the processing tape T. In other words, in case the Braille array 75 is embossed into the marking region 74 beyond the half-cut line 18, the user can recognize that the Braille array 75 has not correctly ended its embossing processing. However, there is the following possibility (although not shown). Namely, suppose a case in which two independent Braille arrays are to be embossed on a single piece of processing tape T with a slightly longer (or wider) blank space therebetween. In this case, if the processing tape T in the tape cartridge 5 has run out on the way (or in the midst) of the blank space, the user may wrongly judge that the embossing operation has finished. This kind of wrong recognition will, however, be prevented if the end mark 73 is embossed.

A description has so far been made about the method of processing a tape as well as about the tape processing apparatus 1 for processing a tape according to this invention. According to this embodiment, the end mark 73 enables even the person who has no handicap in eyesight to confirm that the Braille embossing has accurately been made on the processing tape T. Since the embossing of the end mark is performed by using the structure of the Braille embossing unit 32 of the tape processing apparatus 1, there is no need of preparing a new apparatus, with the result that the tape processing apparatus 1 is not complicated. In addition, the user can recognize the processing tape T as an incomplete one in the following cases since the end mark 73 is not embossed, such cases being, e.g.: where the feeding speed of the tape feeding mechanism 33 on the side of the Braille embossing section 4 is accelerated due, e.g., to clogging of dirt, or the like, resulting in the Braille array 75 being driven or forced out of the processing tape T; and where Braille embossing is kept on going even with a processing tape T which is shorter than a set value due to running out of the tape, or the like, resulting in the Braille array 75 being formed beyond the required range.

As another embodiment, the end mark 73 may be of another embossing pattern. Namely, as shown in FIG. 7A, the end mark 73A may be constituted by two embossed projections 45 which are embossed in the central portion of the marking region 74 at a smaller pitch than the horizontal pitch of an ordinary Braille 42. According to this arrangement, the end mark 73 can be constituted more easily. In this case, too, the end mark 73 can be clearly distinguished from the Braille array 75.

Further, as shown in FIG. 7B, the end mark 73B may also be constituted by a total of nine embossed projections 45 which are embossed at a pitch smaller than the horizontal pitch of the ordinary Braille. In this example, the end mark 73B is more clearly emphasized to thereby clearly distinguish it from the Braille array 75.

Or else, as shown in FIG. 7C, the end mark 73C may be constituted by a plurality of graphically disposed embossed projections 45. In this example, too, the end mark 73 can be clearly distinguished from the Braille array 75. The aforementioned end marks 73A to 73C are arranged to be embossed by using the embossing unit 32. It is needless to say that a description of these end marks shall be given in an operation manual of the tape processing apparatus 1 so that the user can recognize these end marks 73, 73A to 73C distinguish from the Braille array 75.

Still furthermore, the end mark 73 may also be embossed as shown in FIG. 7D on a processing tape T having both the Braille array 75 and the ink-character array 76. In this case, ink-character array 76 is printed in the printing region 71 of the processing tape T by the printing head 22 based on the ink-character data. Further, Braille array 75 is embossed in the embossing region 72 of the processing tape T by the Braille embossing unit 32 based on the Braille data. Still furthermore, the end mark 73 is embossed by the Braille embossing unit 32 in the marking region 74 of the processing tape T. In this manner, there can be formed the processing tape T in which the Braille array 75 and the ink-character array 76 are disposed in parallel with each other. With this kind of processing tape T, it is possible to recognize the end of the embossing of the Braille by means of the end mark 73.

Although not shown, in case the ink-character array and the Braille array are disposed in parallel with each other, the ink-character array is represented shorter, thereby giving rise to the possibility that the ink characters of the ink-character array and the Braille of the Braille array do not always correspond to each other. In such a case, it will be difficult for the person having an ordinary eyesight to see whether the Braille array is finished or not. However, if the end mark 73 is embossed as in this example, the finishing of the Braille array can be easily recognized.

It is further understood by those skilled in the art that the foregoing is the preferred embodiment of the invention, and that various changes and modifications may be made without departing from the spirit and scope thereof.

What is claimed is:

1. A method of processing a tape comprising:
embossing Braille on an elongated rectangular processing tape in an embossing region which is set in advance on the processing tape; and
embossing an end mark which shows an end of a Braille embossing operation, the embossing of the end mark being made in a marking region which follows the embossing region of the processing tape.

2. The method according to claim 1, wherein the processing tape comprises a recording tape and a release tape adhered to a rear surface of the recording tape, the method further comprising forming on a border between the embossing region and the marking region a half-cutting line for cutting only the recording tape.

3. An apparatus for processing a tape, comprising:
Braille embossing means for embossing Braille on an elongated rectangular processing tape based on inputted Braille information;
region-setting means for setting on the processing tape a region for embossing therein Braille;
control means for controlling the Braille embossing means, the control means controlling the Braille embossing means such that Braille are embossed in the embossing region and that an end mark showing an end of a Braille embossing operation is embossed in a marking region which follows the embossing region of the processing tape.

4. The apparatus according to claim 3, wherein the processing tape comprises a recording tape and a release tape adhered to a rear surface of the recording tape, wherein the control means further comprises half-cut means for cutting only the recording tape of the processing tape, the control means controlling the half-cut means such that a half-cut line is formed on a border between the embossing region and the marking region.

5. The apparatus according to claim 3, wherein the end mark is made up of an embossing pattern which is different from an embossing pattern representing Braille.

6. The apparatus according to claim 5, wherein the embossing pattern of the Braille is formed by embossed projections which are selectively embossed in six-point embossing cells, and wherein the embossing pattern of the end mark is formed by embossed projections which are embossed in all of the six-point embossing cells arranged in a narrower width than the ordinary width for the embossing cells.

7. The apparatus according to claim 3, further comprising:
a cartridge mounting section for detachably mounting a tape cartridge into which is housed the elongated processing tape in a rolled shape; and
full-cut means for cutting off the elongated processing tape which is paid out of the mounted tape cartridge, thereby obtaining the elongated rectangular processing tape.

8. The apparatus according to claim 7, further comprising printing means for printing ink characters while feeding the elongated processing-tape, the printing being made before cutting off the tape by the full-cut means.
